(19) United States
(12) Patent Application Publication
(10) Pub. No.: US 2006/0286850 A1
(43) Pub. Date: Dec. 21, 2006

(54) Light knob switch socket assembly

(75) Inventor: Wen Ho Yang, Taipei Hsien (TW)

Correspondence Address: BACON & THOMAS, PLLC, 625 SLATERS LANE, FOURTH FLOOR, ALEXANDRIA, VA, 22314, US

(73) Assignee: Sun Lite Sockets Industry Inc., Taoyuan Hsien (TW)

(21) Appl. No.: 11/153,478

(22) Filed: Jun. 16, 2005

(51) Int. Cl. H01R 13/58

(52) U.S. Cl. 439/457

(57) ABSTRACT

The terminal ends of a dual lead wire are secured against detachment from a pair of terminal jacks by a pair of C-shaped supports positioned adjacent the jacks and engaged by the dual conductors of the wire in a light knob switch socket assembly.

### BACKGROUND OF THE INVENTION

The present invention relates to a light knob switch socket assembly, more particularly, to one that can prevent the leads of a conductor wire connected and fixed to a lighting fixture from detaching or causing poor contact, and ensure good transmission quality for safe use of the lighting fixture.

The construction of a prior art light socket assembly as illustrated in FIG. 1 is essentially comprised of a stand 1 and a socket 2, within the stand 1, the stand 1 being made of insulation materials, and has on its sides provided with two screw terminals 11 and 12 fixed in position with locking screws to respectively connect and hold one-phase dual lead-in wires in place while a knob switch 13 is provided on said stand 1 for the control of turning on or off the lighting fixture; and the light socket 2 being made of conductive material provides a screw base to hold a light bulb in position.

Whereas the switching function of this prior art of the light knob switch socket solely relies on the screw terminals to connect and hold lead-in wires in place, it is vulnerable for the wire leads to fall away from their screw terminals in case that the locking screws loosen up or the lead-in wire is subject to improper pull; or saving such falling away. The lead-in wire may have poor contact with its screw terminal 11 or 12, and inconsistent loading current will affect the transmission quality and even result in a fire hazard due to overloaded lead-in wire.

Another prior art assembly includes terminal jacks 31 and 32 (as illustrated in FIG. 2) instead of the screw terminals 11 and 12 while retaining a stand 3, a light socket 4 and knob switch 33. The terminal jacks 31 and 32 allows the insertion of plug-in of lead-in wires and provides a spring-load clamping device for holding the inserted lead-in wire in place and preventing it from falling away as found in the prior art having lead-in wire held in position by locking screws. However, the terminal to connect lead-in wire of this device is still at the risk of falling away when the lead-in wire is subject to an improper pull, which will directly transmit into said terminal jacks 31 and 32 of the stand 3, even though said terminals of the lead-in wire are inserted into said terminal jacks 31 and 32 of the stand 3.

### BRIEF DESCRIPTION OF THE DRAWINGS

The primary purpose of the present invention is to provide a light knob switch socket assembly that can prevent a lead-in wire connected and fixed to the lighting fixture from falling away or causing poor contact, and ensure good transmission quality for safe use of the light.

To achieve the aforesaid purpose, a lead-in wire support is provided on the stand of the lighting fixture to function as a strain relief for the installation of the lead-in wire so that when the lead-in wire is subject to an improper pull, the force of said pull is sustained by the wire support without being directly transferred to the terminal provided at the stand for the lead-in wire. The technical means and physical structure of the present invention can be better understood by a preferred embodiment in conjunction with the following drawings:

FIG. 1 is a perspective view of a light knob switch socket;

FIG. 2 is a perspective view of another prior art light knob switch socket;

FIG. 3 is an exploded view of the preferred embodiment of the present invention;

FIG. 4 is a top view of the preferred embodiment of the present invention;

FIG. 5 is a perspective view illustrating the appearance of the preferred embodiment of the present invention with the lead-in wire connected; and

FIG. 6 is a perspective view illustrating the appearance of the preferred embodiment of the present invention with the dust-proof casing removed.

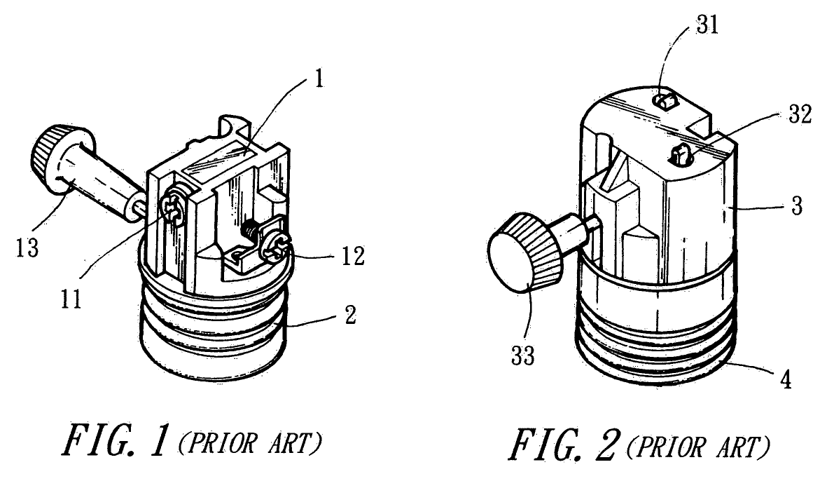

### DESCRIPTION OF THE PREFERRED EMBODIMENT:

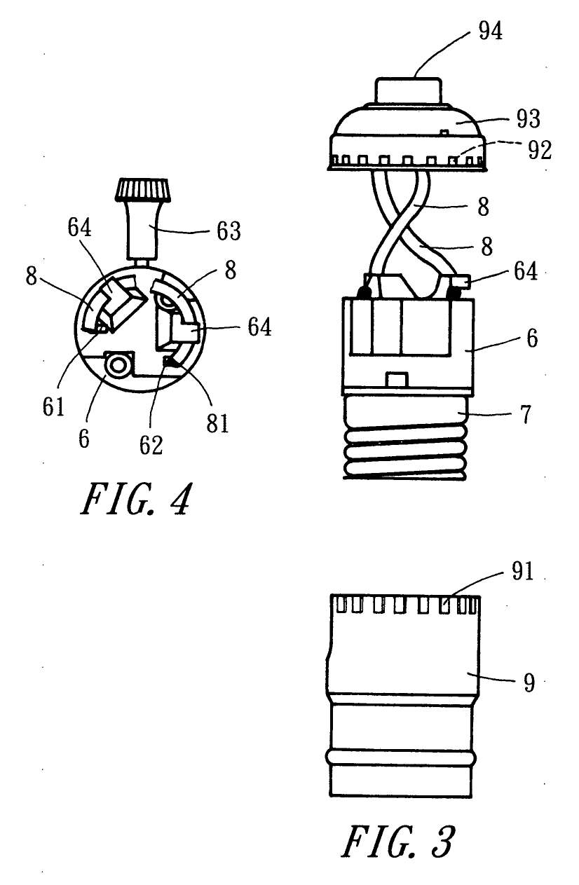

By referring to FIG. 3 and 4, the structure of the preferred embodiment of the present invention is completely identical with the prior art as illustrated in FIG. 2, and is essentially comprised of a stand 6, a light socket 7, a knob switch 63 and two terminal jacks 61 and 62; Given the aforesaid, the characteristics of the present invention are as follows:

A pair of wire supports 64 (also refer to FIG. 6) is provided on the stand 6 to serve as the strain relief for the installation of a lead-in wire 8, so that when the lead-in wire 8 is subject to an improper pull, the force of such pull is sustained by the wire support 64 without being directly transferred to a terminal 81 of the lead-in wire 8.

Each wire support 64 and the stand 6 form a square “C” shape to facilitate the installation of said lead-in wire 8.

Each wire support 64 and terminal jacks 61 and 62 are provided on the same side on the stand 6 and adjacent each other to facilitate the installation of said terminals 81 of lead-in wire 8, and said stand 6 is be provided with at least one wire support 64 depending on the installation requirements of lead-in wire 8.

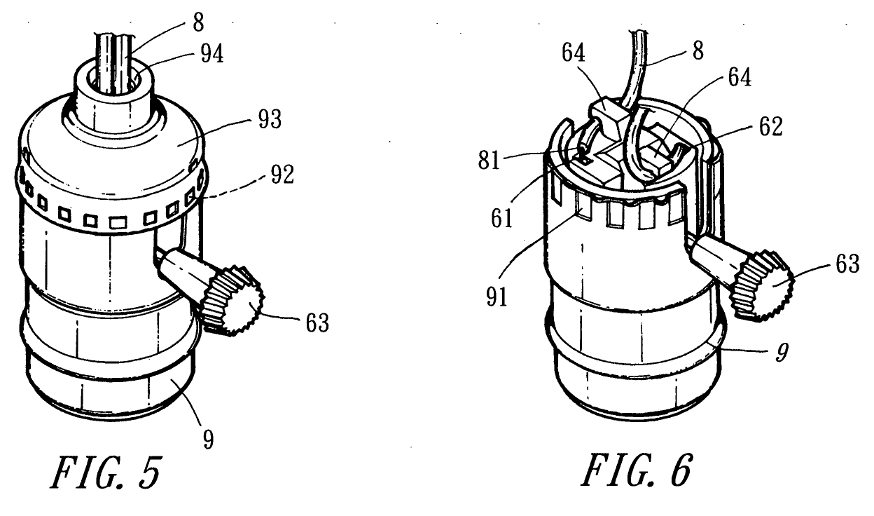

Light socket 7 is made of conductive material, to protect from electric shock, and a protective jacket 9, hollow and inter-lined with insulating material may be inserted onto said light socket 7 as illustrated in FIGS. 3 and 6. A multiple of restricting convex and concave interleaved walls 91 may be further provided around the top edge of said protective jacket 9 and a multiple of mating walls 92, on the inner wall of a dust-proof casing 93 as illustrated in FIG. 3 and 5 to secure the protective jacket 9 in position and stop the invasion of dust. Furthermore, a wire jack 94 may be provided at the center of the dome of said dust-proof casing 93 to allow the lead-in wire 8 to penetrate through and thus restricting the direction of said lead-in wire 8. In turn, said stand 6 is given dust-proof protection due to the segregation provided by the coverage of said dust-proof casing 93, and the external pull acting upon said lead-in wire 8 will never be transferred to a terminal 81 of said lead-in wire 8 on the stand 6 since the wire supports 64 are also segregated by the coverage provided by said dust-proof casing 93 to ensure that the terminals 81 of the lead-in wire 8 does not fall away from terminal jacks 61 and 62 on the stand 6 as a safety feature.

The present invention therefore provides the following additional advantages when compared with those of the prior art: (1) to protect the lead-in wires inserted and held in position inside the stand from falling away even when subject to improper pull for safe use of the lighting fixture; (2) to prevent electric shock; and (3) to ensure good power transmission quality of the lead-in wire by the dust-proof casting which frustrates the invasion of dust and bugs.

1. A light knob switch socket assembly including a stand having a light socket and a knob switch for controlling turning on or off a light, and a pair of terminal jacks for securing ends of a dual conductor lead-in wire inserted through a cover secured to a protective jacket, said cover and protective jacket collectively enclosing the stand and light socket, the improvement comprising:
a pair of supports provided on the stand, each support being positioned adjacent a terminal jack and engageable by a conductor of the lead-in wire for providing strain relief and sustaining a force of an improper pull on the lead-in wire to prevent detachment of the ends of the conductors from the terminal jacks.

2. The light knob switch socket assembly of claim 1, wherein each support is of a C-shaped configuration.
